(19) United States
(12) Patent Application Publication
(10) Pub. No.: US 2015/0042695 A1
(43) Pub. Date: Feb. 12, 2015

(54) DISPLAY ELEMENT AND DISPLAY DEVICE

(71) Applicant: Sharp Kabushiki Kaisha, Osaka-shi, Osaka (JP)

(72) Inventors: Ryohki Itoh, Osaka-shi (JP); Takaharu Yamada, Osaka-shi (JP); Kazuyoshi Hamanaka, Osaka-shi (JP)

(21) Appl. No.: 14/384,182

(22) PCT Filed: Mar. 21, 2013
(86) PCT No.: PCT/JP2013/058037

§ 371 Date: Sep. 10, 2014

(30) Foreign Application Priority Data
Mar. 27, 2012 (JP) 2012-072199

(51) Int. Cl. G09G 3/36

(52) U.S. Cl. CPC G09G 3/3607
USPC 345/690; 345/88

(57) ABSTRACT

In a display element (10), first and second sub-picture elements share a first signal line (S(i)) in common, third and fourth sub-picture elements share a second signal line (S(i+1)) in common, fifth and sixth sub-picture elements share a third signal line (S(i+2)) in common, the first, third, and fifth sub-picture elements are provided on one sides of the corresponding signal lines, and the second, fourth, and sixth sub-picture elements are provided on the other sides of the corresponding signal lines, and respective switching elements of two sub-picture elements displaying a primary color with the highest luminance out of the first through sixth sub-picture elements when the first through sixth sub-picture elements display an achromatic color are connected with one of a first scanning line (Ga(j)) and a second scanning line (Gb(j)).

### TECHNICAL FIELD

The present invention relates to an active matrix display element having a dual gate structure, and to a display device.

### BACKGROUND ART

Active matrix display devices are used in a variety of electronic devices such as television receivers, monitors for personal computers, smart phones, and tablet terminals. In order to improve display quality, such display devices have come to have a larger number of picture elements. In other words, such display devices have come to have higher definitions.

On the other hand, the increase in the number of all picture elements in a display device means the increase in the number of all source drivers and the number of all gate drivers in a display element. In particular, source drivers are designed to output voltages corresponding to a large number of tones and accordingly require high costs. Therefore, the increase in the number of all picture elements in the display device involves the increase in costs of the display device.

Patent Literature 1 describes an active matrix liquid crystal display device, comprising: picture element electrodes provided in an M×N (M and N are any positive integers) matrix manner; 2N scanning lines 8-1 to 8-2N, every two of which are provided with respect to each display line in a scanning direction; M/2 data lines 6-1 to 6-M/2; first TFT gates G1 each of which is connected with any data line and one of two scanning lines in each display line; and second TFT gates G2 each of which is connected with said any data line and the other of the two scanning lines in said each display line, in order to reduce the number of all source drivers included in the display device (see FIG. 1 of Patent Literature 1).

Patent Literature 2 describes a technique for realizing a liquid crystal display panel capable of performing dot inversion driving or similar driving so as to obtain good image quality. Specifically, Patent Literature 2 describes a liquid crystal display panel in which a connection between a gate of a TFT and a scanning line is made oppositely between an odd-numbered display line and an even-numbered display line (see FIG. 1 of Patent Literature 2).

Patent Literature 3 describes a technique of a liquid crystal display panel (see FIG. 2(a) of Patent Literature 3) in which every pair of two picture elements adjacent to each other in a direction in which scanning signal lines GL extent (x direction) share one image signal line DL in common, wherein common inversion driving is performed with respect to each picture element column (see FIG. 2(b)) so as to realize an inversion form identical with dot inversion driving.

A structure of a display element in which a pair of (two) gate bus lines are provided with respect to one display line in a row direction and two sub-picture elements adjacent to each other in the row direction are connected with one source bus line via respective TFTs is hereinafter referred to as a dual gate structure.

As described above, a display element having the dual gate structure can reduce the number of all source bus lines and accordingly can reduce the number of all source drivers. On the other hand, there is a case where a user who sees an image displayed by a display device including the display element having the dual gate structure sees a longitudinal streak. This longitudinal streak is generated due to a difference in charging ratio between sub-picture elements adjacent to each other in a row direction and sharing one source bus line in common when data signals are written in the two sub-picture elements. A description will be provided below as to this longitudinal streak with reference to FIG. 1 of Patent Literature 1 and FIG. 7 of the present specification.

In a display device illustrated in FIG. 1 of Patent Literature 1, a blue sub-picture element is connected with a gate bus line 8-i and a source bus line 6-j via a TFT gate G1. This sub-pixel is hereinafter referred to as B(j). A green sub-picture element is connected with a gate bus line 8-i+1 and the source bus line 6-j via a TFT gate G2. This sub-pixel is hereinafter referred to as G(j).

B(j) and G(j) share the source bus line 6-j in common. Accordingly, the display device writes a data signal in B(j) and G(j) at different timings (writing may be hereinafter referred to as charging). Specifically, as illustrated in FIG. 7 of the specification, a voltage corresponding to a certain tone is inputted as a data signal to the source bus line 6-j. Along with the input, a first scanning signal is written in the gate bus line 8-i and the TFT gate G1 is put in an ON-state, so that B(j) is charged. After a predetermined time has lapsed, the first scanning signal is stopped and the TFT gate G1 is put in an

OFF-state. Thereafter, a second scanning signal is written in the gate bus line 8-i+1 and the TFT gate G2 is put in an ON-state, so that G(j) is charged. After a predetermined time has lapsed, the TFT gate G2 is put in an OFF-state.

In the process of charging, as illustrated by broken lines in FIG. 7, respective voltages of the data signal, the first scanning signal, and the second scanning signal go through transient regions where the voltages increase gradually, and thereafter reach predetermined voltages. Each transient region of the signals is hereinafter referred to as a rising period. When B(j) is charged, a rising period of the data signal overlaps a rising period of the first scanning signal. On the other hand, when G(j) is charged, the rising period of the data signal does not overlap a rising period of the second scanning signal, since the data signal has already reached a predetermined voltage. Consequently, a charging ratio of B(j) is lower than a charging ratio of G(j). In other words, in two sub-picture elements sharing one source bus line in common, a charging ratio of a picture element connected with a gate bus line to which the first scanning signal is inputted is lower than a charging ratio of a picture element connected with a gate bus line to which the second scanning signal is inputted.

Referring to FIG. 1 of Patent Literature 1 again, in a picture element surrounded by a broken line, a red sub-picture element (hereinafter referred to as R(j−1)) connected with a source bus line 6-j−1 and B(j) are connected with the gate bus line 8-i. Consequently, charging ratios of R(j−1) and B(j) are low. On the other hand, G(j) is connected with the gate bus line 8-i+1. Consequently, a charging ratio of G(j) is high.

As for a picture element adjacent in a row direction to the picture element surrounded by the broken line, out of sub-picture elements in the adjacent picture element which share a source bus line 6-j+1 in common, a G sub-picture element (hereinafter referred to as G(j+1)) is connected with the gate bus line 8-j and so has a low charging ratio, and an R sub-picture element (hereinafter referred to as R(j+1)) has a high charging ratio. A B sub-picture element connected with a source bus line 6-j+2 (hereinafter referred to as B(j+2)) (not illustrated) is connected with the gate bus line 8-i+1 and so has a high charging ratio.

As described above, in one of the adjacent two picture elements, charging ratios of R(j−1), G(j), and B(j) are “low”, “high”, and “low”, respectively. In the other of the adjacent two picture elements, charging ratios of R(j+1), G(j+1), and B(j+2) are “high”, “low”, and “high”, respectively. That is, in a case where the two picture elements display achromatic colors of the same tone, R(j−1) in one of the two picture elements and R(j+1) in the other of the two picture elements have different luminances. Similarly, in that case, G(j) and G(j+1) have different luminances, and B(j) and B(j+2) have different luminances. Consequently, in the case where the two picture elements display achromatic colors of the same tone, a color actually displayed by one of the two picture elements is different from a color actually displayed by the other of the two picture elements. A user who sees this state sees a longitudinal streak.

Each of Patent Literatures 4 and 5 describes a liquid crystal display device having a dual gate structure, in which sub-picture elements are arranged such that a red sub-picture element (R1) is provided at one side of DL1 and is connected with GL1, a green sub-picture element (G1) is provided at the other side of DL1 and is connected with GL2, a blue sub-picture element (B1) is provided at one side of DL2 and is connected with GL2, a red sub-picture element (R2) is provided at the other side of DL2 and is connected with GL1, a green sub-picture element (G2) is provided at one side of DL3 and is connected with GL2, and a blue sub-picture element (B2) is provided at the other side of DL3 and is connected with GL1 (see FIG. 6 of Patent Literature 4 and FIG. 6 of Patent Literature 5).

In this liquid crystal display device, both of G1 and G2 are connected with GL2, and both of R1 and R2 are connected with GL1. This configuration allows subduing a difference in luminance between green picture elements and a difference in luminance between red picture elements, thereby improving display quality.

### CITATION LIST

### Patent Literatures

[Patent Literature 1]

Japanese Patent Application Publication No. 5-265045 (published on Oct. 15, 1993)

[Patent Literature 2]

Japanese Patent Application Publication No. 10-73843 (published on Mar. 17, 1998)

[Patent Literature 3]

Japanese Patent Application Publication No. 2008-70763 (published on Mar. 27, 2008)

[Patent Literature 4]

U.S. Patent Application Publication No. US2008/0079678 A1 (published on Apr. 3, 2008)

[Patent Literature 5]

U.S. Patent Application Publication No. US2011/0069057 A1 (published on Mar. 24, 2011)

### SUMMARY OF INVENTION

### Technical Problem

However, there is a case where a user sees a longitudinal streak also in the liquid crystal display devices described in Patent Literatures 4 and 5. Such a longitudinal streak is generated mainly due to misalignment in a process of manufacturing a liquid crystal display device, particularly in a process of manufacturing a substrate having TFTs (which may be hereinafter referred to as a TFT substrate).

The TFT substrate is manufactured in such a manner that, in the manufacturing process thereof, gate bus lines, source bus lines, TFTs, picture element electrodes, a plurality of insulating layers etc.

are sequentially formed on a transparent substrate. Alignment of a device for manufacturing a TFT substrate is adjusted such that respective TFTs and respective picture element electrodes of sub-picture elements can be provided at proper positions with respect to source bus lines and gate bus lines. However, in mass-producing liquid crystal display devices, it is difficult to completely eliminate a possibility of misalignment in the manufacturing device. Furthermore, there is a case where misalignment does not occur similarly on a whole area of the TFT substrate but occur with in-plane distribution. The in-plane distribution of misalignment tends to be worsened as the TFT substrate is larger.

A main cause for a longitudinal streak found by a user is misalignment of TFTs and picture element electrodes in a direction perpendicular to source bus lines, i.e. in a row direction. For example, assume that in the liquid crystal display element illustrated in FIG. 6 of Patent Literature 4, the sub-picture elements R1, G1, B1, R2, G2, and B2 are misaligned leftward relative to source bus lines DL1 to DL3. In this case, distances between source bus lines and sub-picture elements provided at left sides of the source bus lines are longer than proper distances. In contrast, distances between source bus lines and sub-picture elements provided at right sides of the source bus lines are shorter than proper distances.

Consequently, parasitic capacitances Csd between source bus lines and sub-picture elements provided at the left sides of the source bus lines are smaller than parasitic capacitances Csd between source bus lines and sub-picture elements provided at the right sides of the source bus lines. Specifically, Csd in R1 is smaller than Csd in R2, Csd in G1 is larger than Csd in G2, and Csd in B1 is smaller than Csd in B2. As above, all sub-picture elements of red, green, and blue have different Csd. Consequently, individual sub-picture elements retain different potentials after being charged. Accordingly, colors displayed by the sub-picture elements have different luminances, and a user may see this difference in luminance as a longitudinal streak.

The present invention was made in view of the foregoing problem. An object of the present invention is to provide a display element having a dual gate structure, capable of further subduing generation of a longitudinal streak visible to a user.

### Solution to Problem

In order to solve the foregoing problem, a display element in accordance with one aspect of the present invention is a display element, including: a first signal line, a second signal line, and a third signal line which extend in one direction; a first scanning line and a second scanning line which extend in a direction crossing the first signal line, the second signal line, and the third signal line; and first through sixth sub-picture elements provided between the first scanning line and the second scanning line, the first sub-picture element being provided on one side of the first signal line, displaying a first primary color, and including a first switching element connected with the first signal line and the second scanning line, the second sub-picture element being provided on the other side of the first signal line, displaying a second primary color different from the first primary color, and including a second switching element connected with the second signal line and the first scanning line, the third sub-picture element being provided on one side of the second signal line, displaying a third primary color different from the first primary color and the second primary color, and including a third switching element connected with the second signal line and the second scanning line, the fourth sub-picture element being provided on the other side of the second signal line, displaying one of the first primary color, the second primary color, and the third primary color, and including a fourth switching element connected with the second signal line and the first scanning line, the fifth sub-picture element being provided on one side of the third signal line, displaying another one of the first primary color, the second primary color, and the third primary color which another one is different from said one displayed by the fourth sub-picture element, and including a fifth switching element connected with the third signal line and the second scanning line, and the sixth sub-picture element being provided on the other side of the third signal line, displaying still another one of the first primary color, the second primary color, and the third primary color which still another one is different from said one displayed by the fourth sub-picture element and said another one displayed by the fifth sub-picture element, and including a sixth switching element connected with the third signal line and the first scanning line, and two of the first through sixth sub-picture elements displaying a primary color with a highest luminance out of the first through third primary colors when the first through sixth sub-picture elements display an achromatic color, and respective switching elements of said two sub-picture elements being each connected with one of the first scanning line and the second scanning line.

For a fuller understanding of the nature and advantages of the invention, reference should be made to the ensuing detailed description taken in conjunction with the accompanying drawings.

### Advantageous Effects of Invention

A display element and a display device in accordance with one aspect of the present invention can subdue generation of a longitudinal streak which would be visible to a user in an image displayed by a display element and a display device.

### BRIEF DESCRIPTION OF DRAWINGS

FIG. 1 is a plan view schematically illustrating a display element in accordance with one embodiment of the present invention.

FIG. 2 is a plan view schematically illustrating a display element in accordance with one embodiment of the present invention.

FIG. 3 is a plan view schematically illustrating a display element in accordance with one embodiment of the present invention.

FIG. 4 is a plan view schematically illustrating a display element in accordance with one embodiment of the present invention.

FIG. 5 is a plan view schematically illustrating a display element in accordance with one embodiment of the present invention.

FIG. 6 is a plan view schematically illustrating a display element in accordance with one embodiment of the present invention.

FIG. 7 is a view illustrating a timing chart for explaining a data signal and a scanning signal in a display element having a dual gate structure.

### DESCRIPTION OF EMBODIMENTS

### First Embodiment

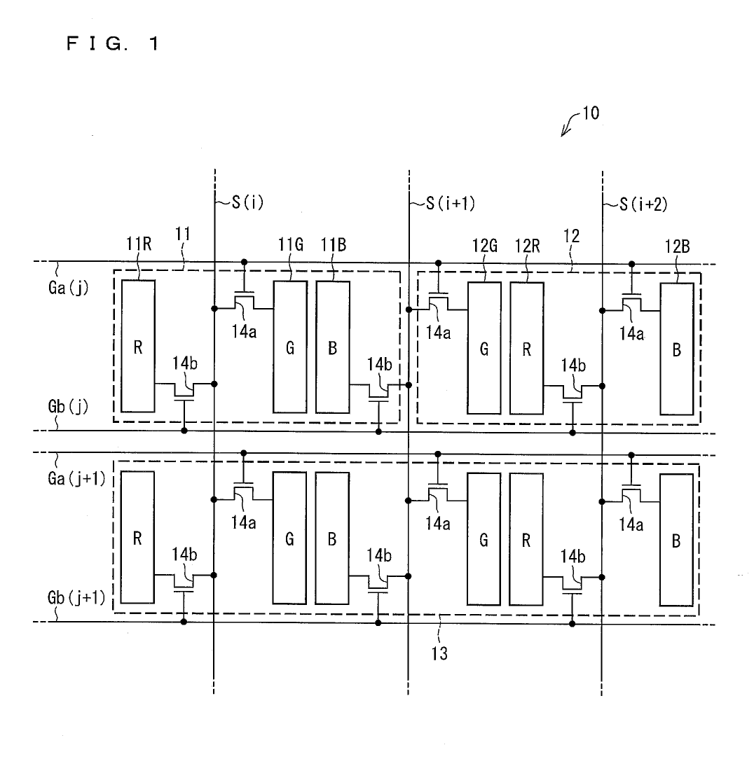

The following description will discuss a display element 10 in accordance with First Embodiment of the present invention, with reference to FIGS. 1, 2, and 7.

(Outline of Display Element 10)

FIG. 1 is a plan view schematically illustrating the display element 10, to be more specific, schematically illustrating a TFT substrate included in the display element 10. Note that the TFT substrate will be described later. The display element 10 is a liquid crystal display element including two transparent substrates and a liquid crystal layer sandwiched between the two transparent substrates. The display element 10 has a dual gate structure as described later.

One of the two substrates has, on a surface thereof, at least gate bus lines, source bus lines, TFTs each serving as a switching element, picture element electrodes, a plurality of insulating layers etc. which are sequentially laminated. The one of the two substrates may be hereinafter referred to as a TFT substrate. The other of the two substrates has color filters (hereinafter abbreviated as CF) each for transmitting light of a particular color. This substrate may be hereinafter referred to as a CF substrate. A description will be provided below as to a case where the display element 10 includes color filters each of which transmits red (R), green (G), or blue (B) light. Note that three color filters included in the display element 10 are not limited to transmission of R, G, and B light. Alternatively, the three color filters may transmit, for example, cyan, magenta, and yellow light.

The liquid crystal layer is sandwiched between the TFT substrate and the CF substrate, and changes intensity of transmitted light in accordance with intensity of an externally applied electric field. In order to apply an electric field, the display element 10 has an additional electrode, aside from the picture element electrodes. The additional electrode is called a counter electrode or a common electrode, depending on an alignment mode of a liquid crystal which is employed by the display element 10. Note that the alignment mode and a driving method employed by the display element 10 are not particularly limited. As such, any alignment mode and any driving method, such as TN, MVA, IPS, FFS, TBA, PSA, optical alignment, and multi picture element, can be alternatively employed.

In the present embodiment, a description will be made as to a case where the display element 10 is a liquid crystal display element as above. However, the display element 10 is not limited to a liquid crystal display element. The present invention is applicable to any display element, provided that the display element has a dual gate structure, regardless of how sub-picture elements display colors.

(Source Bus Lines)

As illustrated in FIG. 1, the display element 10 includes a plurality of source bus lines (signal lines) extending in one direction. The one direction in which the source bus lines extend may be hereinafter referred to as a column direction.

In a case where the number of all picture elements included in the display element 10 is 2M×N (M and N are any positive integers), the number of source bus lines is 2M×3/2=3M. In FIG. 1, a first source bus line is denoted by S(i), a second source bus line is denoted by S(i+1), and a third source bus line is denoted by S(i+2). Here, i is any integer which falls in a range of 1≦i≦3M−2.

The source bus lines are connected with a source driver (not illustrated). The source driver outputs data signals, via the respective source bus lines.

(Gate Bus Lines)

As illustrated in FIG. 1, a first gate bus line (scanning line) Ga and a second gate bus line Gb are provided so as to extend in a direction crossing the first source bus line S(i), the second source bus line S(i+1), and the third source bus line S(i+2). The direction in which the gate bus lines extend may be hereinafter referred to as a row direction. In the display element 10, the first gate bus line Ga and the second gate bus line Gb are provided with respect to a display line of one row, and so the number of all the gate bus lines is 2N. In FIG. 1, gate bus lines on j-th row are denoted by Ga(j) and Gb(j), and gate bus lines on j+1st row are denoted by Ga(j+1) and Gb(j30 1). Herein, j is any integer which falls in a range of 1≦j≦2N−1.

The gate bus lines are connected with a gate driver (not illustrated). The gate driver outputs, via the gate bus lines Ga and Gb on each row, scanning signals whose polarity is reversed for each row.

(Unit Picture Element 13)

As illustrated in FIG. 1, a unit picture element 13 included in the display element 10 includes first through sixth sub-picture elements provided between a first gate bus line and a second gate bus line. A first sub-picture element 11R, a second sub-picture element 11G, and a third sub-picture element 11B constitute a first picture element 11. A fourth sub-picture element 12G, a fifth sub-picture element 12R, and a sixth sub-picture element 12B constitute a second picture element 12. That is, the unit picture element 13 is made up of the first picture element 11 and the second picture element 12. The display element 10 is configured such that a plurality of unit picture elements 13, each serving as a repeating unit, are provided both in the row direction and the column direction.

(First Picture Element 11)

As illustrated in FIG. 1, each of the sub-picture elements included in the first picture element 11 includes (i) a CF which transmits one of three primary colors of red, green, and blue, (ii) a picture element electrode, and (iii) a switching element (TFT) by which the picture element electrode is connected with a source bus line and a gate bus line. In FIG. 1, the CF included in each sub-picture element is not illustrated, and only a color (R, G, or B) of light transmitted by the CF is illustrated.

A picture element electrode included in the first sub-picture element 11R is provided on one side (left side) of the first source bus line S(i) and is connected with the first source bus line S(i) and the second gate bus line Gb(j) via a TFT (first switching element). As illustrated in FIG. 1, a TFT, by which the second gate bus line Gb is connected with the picture element electrode, is denoted by a TFT 14b. Furthermore, the first sub-picture element 11R includes a CF which transmits light of red which is a first primary color. That is, the first sub-picture element 11R is a sub-picture element which displays a red color which is the first primary color.

A picture element electrode included in the second sub-picture element 11G is provided on the other side (right side) of the first source bus line S(i) and is connected with the first source bus line S(i) and the first gate bus line Ga(j) via a TFT (second switching element). As illustrated in FIG. 1, a TFT, by which the first gate bus line Ga is connected with the picture element electrode, is denoted by a TFT 14a. Furthermore, the second sub-picture element 11G includes, as a second color filter, a CF which transmits light of green which is a second primary color. That is, the second sub-picture element 11G is a sub-picture element which displays a green color which is the second primary color.

A picture element electrode included in the third sub-picture element 11B is provided on one side (left side) of the second source bus line S(i+1), and is connected with the second source bus line S(i+1) and the second gate bus line Gb(j) via a TFT 14b (third switching element). The third sub-picture element 11B includes, as a third color filter, a CF which transmits light of blue which is a third primary color. That is, the third sub-picture element 11B is a sub-picture element which displays a blue color which is the third primary color. As described above, respective CFs of three colors in the first picture element 11 are aligned in the order of “R, G, and B”. The order of aligning CFs may be hereinafter referred to as simply a color alignment.

### (Second Picture Element 12)

As illustrated in FIG. 1, a picture element electrode included in the fourth sub-picture element 12G is provided on the other side (right side) of the second source bus line S(i+1), and is connected with the second source bus line S(i+1) and the first gate bus line Ga(j) via a TFT14a (fourth switching element). The fourth sub-picture element 12G includes a CF which transmits light of green which is the second primary color.

A picture element electrode included in the fifth sub-picture element 12R is provided on one side (left side) of the third source bus line S(i+2), and is connected with the third source bus line S(i+2) and the second gate bus line Gb(j) via a TFT14b (fifth switching element). The fifth sub-picture element 12R includes a CF which transmits light of red which is the first primary color.

A picture element electrode included in the sixth sub-picture element 12B is provided on the other side (right side) of the third source bus line S(i+2), and is connected with the third source bus line S(i+2) and the first gate bus line Ga(j) via a TFT14a (sixth switching element). The sixth sub-picture element 12B includes a CF which transmits light of blue which is the third primary color. A color alignment of the three colors in the second picture element 12 is “G, R, and B”.

A color alignment in the unit picture element 13, which is made up of the first picture element 11 and the second picture element 12, is thus “R, G, B, G, R, and B.” In this color alignment, G, which is a primary color displayed by the fourth sub-picture element, is different from B which is the third primary color. B, which is a primary color displayed by the sixth sub-picture element, is different from R which is the first primary color. Accordingly, in a case where a plurality of unit picture elements 13 are aligned in the row direction, any adjacent sub-picture elements display respective different primary colors. Note that, in a color alignment of the unit picture element 13, sub-picture elements displaying identical primary colors may be adjacent to each other, but are more preferably not adjacent to each other. In a color alignment in which sub-picture elements displaying identical primary colors are not adjacent to each other, sub-picture elements which display primary colors that would cause a difference in luminance due to an element structure (later described) are spaced from each other. The display element 10 can therefore monochromatically display the primary colors, without emphasis on the difference in luminance. It follows that the display element 10 can further subdue a longitudinal streak visible to a user.

(Dual Gate Structure)

According to the display element 10, a pair of gate bus lines are thus provided with respect to one (1) display line in the row direction. Furthermore, picture element electrodes of two sub-picture elements, which are adjacent to each other in the row direction, are connected with one (1) source bus line via the respective TFTs 14a and 14b. Hereinafter, a structure in which two sub-picture elements, adjacent to each other in the row direction, share one (1) source bus line in common is referred to as a dual gate structure.

(Longitudinal Streak due to Element Structure)

Luminance of each sub-picture element included in the display element 10 varies depending on a charging ratio of a data signal written in the each sub-picture element. In a case where (i) data signals of identical voltages are written in two sub-picture elements including CFs of identical colors and (ii) charging ratios in the two sub-picture elements are different from each other, there occurs a difference in luminance between colors displayed by the two sub-picture elements. In particular, since green has the highest luminance out of red, green, and blue when an achromatic color is displayed, a difference in luminance of green, would be more likely to be visible to a user as a longitudinal streak.

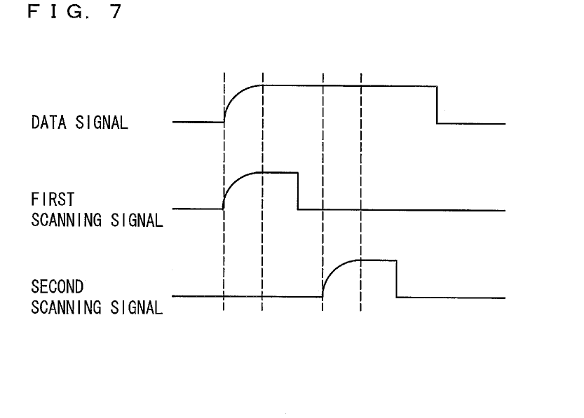

Here, attention is paid to how individual sub-picture elements are charged in a display element having a dual gate structure. As has been described in the Background of the Art, in a display element having a dual gate structure, two sub-picture elements sharing one (1) source bus line in common are charged at different timings (see FIG. 7). This is true also for the display element 10. By outputting a first scanning signal and a second scanning signal at different timings, the display element 10 separately charges a sub-picture element connected with the first gate bus line Ga and a sub-picture element connected with the second gate bus line Gb. In this case, a rising period of the first scanning signal overlaps a rising period of a data signal. On the other hand, a rising period of the second scanning signal does not overlap the rising period of the data signal. Consequently, a charging ratio of the sub-picture element connected with the first gate bus line Ga is lower than a charging ratio of the sub-picture element connected with the second gate bus line Gb.

According to the display element 10, the second sub-picture element 11G and the fourth sub-picture element 12G are connected with the first gate bus line Ga(j) (see FIG. 1). That is, in adjacent picture elements, both of two picture elements which transmit light of green which is a primary color having the highest luminance out of red, green, and blue when an achromatic color is displayed are connected with the first gate bus line Ga(j). Consequently, there is no difference in luminance between green colors respectively displayed by the second sub-picture element 11G and the fourth sub-picture element 12G.

Similarly, both of the first sub-picture element 11R which displays a red color and the fifth sub-picture element 12R which displays a red color are connected with the second gate bus line Gb(j). Consequently, there is no difference in luminance between red colors respectively displayed by the first sub-picture element 11R and the fifth sub-picture element 12R.

As described above, according to the display element 10, out of sub-picture elements which display the three primary colors of red, green, and blue, there is no difference in charging ratio between sub-picture elements displaying a green color which has the strongest influence on visibility, luminance, and chromaticity of a displayed color. Green is a primary color having the highest luminance out of red, green, and blue when the display element 10 displays an achromatic color.

A difference in charging ratio occurs only between sub-picture elements displaying a blue color which has the lowest luminance and has the smallest influence on a displayed color. Consequently, differences in luminance and chromaticity are small between (i) an achromatic color displayed by the first picture element 11 having a color alignment of “R, G, and B” and (ii) an achromatic color displayed by the second picture element 12 having a color alignment of “G, R, and B.” This causes a longitudinal streak to be hardly visible even when the first picture element 11 and the second picture element 12 display a half tone. That is, the display element 10 can subdue generation of a longitudinal streak visible to a user.

(Longitudinal Streak due to Manufacturing Process)

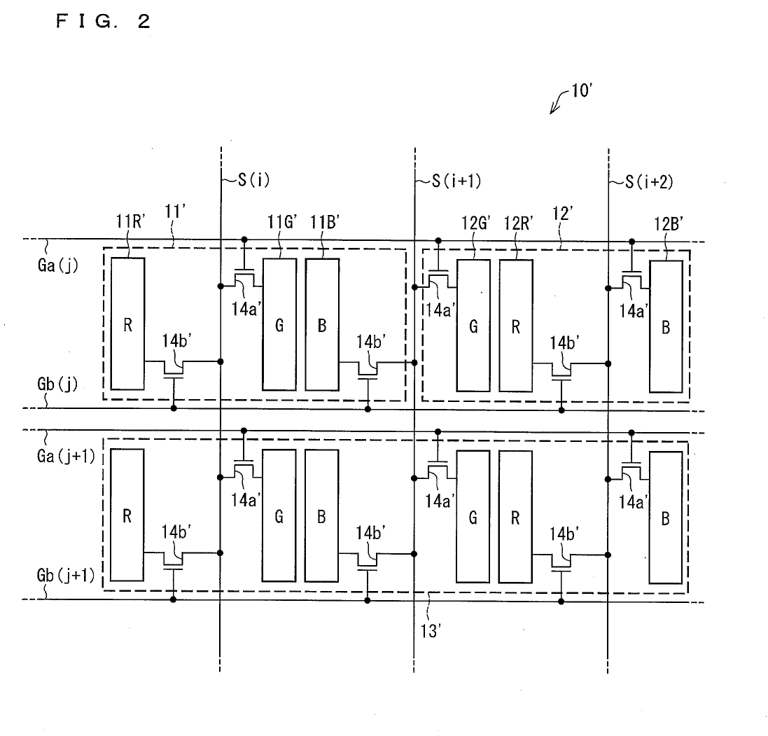

In a display element having a dual gate structure, other than a longitudinal streak due to the aforementioned element structure, there is a possibility that a longitudinal streak visible to a user is generated due to a manufacturing process. The following description will discuss the longitudinal streak due to the manufacturing process with reference to FIG. 2. Note that the manufacturing process here is a process of manufacturing a TFT substrate in particular.

The TFT substrate is manufactured by sequentially forming, on a transparent substrate, gate bus lines, source bus lines, TFTs, picture element electrodes, a plurality of insulating layers, and the like. Alignment of a device for manufacturing a TFT substrate is adjusted such that a TFT and a picture element electrode of each sub-picture element can be appropriately provided with respect to a corresponding source bus line and a corresponding gate bus line. However, it is difficult to completely eliminate misalignment in the manufacturing device. In that case, a TFT and a picture element electrode of each sub-picture element will be misaligned with respect to a corresponding source bus line extending in a column direction and a corresponding gate bus line extending in a row direction.

A possible main cause for a longitudinal streak visible to a user is misalignment of TFTs and picture element electrodes in a direction perpendicular to a corresponding source bus line, i.e. in a row direction. FIG. 2 illustrates, as an example, a display element 10′ in which TFTs and picture element electrodes are misaligned leftward from predetermined positions with respect to source bus lines and gate bus lines. Since the TFTs and the picture element electrodes are misaligned leftward, (i) each distance between a corresponding source bus line and a corresponding TFT which is provided on a left side of the corresponding source bus line and (ii) each distance between the corresponding source bus line and a corresponding sub-picture element which is provided on the left side of the corresponding source bus line become longer, whereas (i) each distance between a corresponding source bus line and a corresponding TFT which is provided on a right side of the corresponding source bus line and (ii) each distance between the corresponding source bus line and a corresponding sub-picture element which is provided on the right side of the corresponding source bus line become shorter.

A first parasitic capacitance, formed between a source bus line and a drain electrode of a TFT in a sub-picture element is in inverse proportion to a distance between the source bus line and the drain electrode. A second parasitic capacitance, formed between the source bus line and a picture element electrode in the sub-picture element, is in inverse proportion to a distance between the source bus line and the picture element electrode. The first parasitic capacitance and the second parasitic capacitance constitute a parasitic capacitance Csd. This causes a difference between (i) a parasitic capacitance Csd in a sub-picture element on a left side of a source bus line and (ii) a parasitic capacitance Csd in a sub-picture element on a left side of the source bus line. Such a difference in parasitic capacitance Csd results in a difference in storage capacitance between the sub-picture elements, and ultimately causes a difference in potential between the sub-picture elements which are charged.

In a unit picture element 13′, a green color is displayed by a second sub-picture element 11G′ and a fourth sub-picture element 12G′. The sub-picture elements 11G′ and 12G′ are provided on right sides of respective source bus lines. Accordingly, there is no difference between a parasitic capacitance Csd of the second sub-picture element 11G′ and a parasitic capacitance Csd of the fourth sub-picture element 12G′. It follows that there is no difference in luminance between the second sub-picture element 11G′ and the fourth sub-picture element 12G′. Even in a case where a misalignment of a manufacturing device occurs in a process of manufacturing a TFT substrate, there is no difference in luminance between sub-picture elements each displaying a green color which is a primary color with the highest luminance when an achromatic color is displayed.

Similarly, in the unit picture element 13′, a first sub-picture element 11R′ displaying a red color and a fifth sub-picture element 12R′ displaying a red color are provided on left sides of respective source bus lines. Consequently, there is no difference in luminance between the first sub-picture element 11R and the fifth sub-picture element 12R′.

On the other hand, in the unit picture element 13′, a third sub-picture element 11B′ displaying a blue color is provided on a left side of a source bus line, whereas a sixth sub-picture element 12B′ displaying a blue color is provided on a right side of a source line. Consequently, there is possibly a difference in luminance between the third sub-picture element 11B′ and the sixth sub-picture element 12B′. However, when an achromatic color is being displayed, luminance of blue is significantly lower than that of green. Besides, photopic luminosity function for blue is significantly lower than that for green. Accordingly, a difference in color due to a difference in luminance of blue is extremely less likely to be visible as a longitudinal streak to a user.

As described above, in the display element 10, there is no difference in luminance between sub-picture elements displaying a green color which has the strongest influence on visibility, luminance, and chromaticity of a displayed color, even in a case where misalignment of a manufacturing device occurs in a process of manufacturing a TFT substrate. There is a difference in luminance only between sub-picture element s displaying a blue color which has the lowest luminance and which has the smallest influence on a displayed color. Consequently, there are only small differences in luminance and chromaticity between (i) an achromatic color displayed by the first picture element 11 having a color alignment of “R, G, and B” and (ii) an achromatic color displayed by the second picture element 12 having a color alignment of “G, R, and B.” This causes a longitudinal streak to be less likely to be visible to a user even when a half tone is displayed. That is, the display element 10 can further subdue generation of a longitudinal streak visible to a user.

(Modification of Display Element 10)

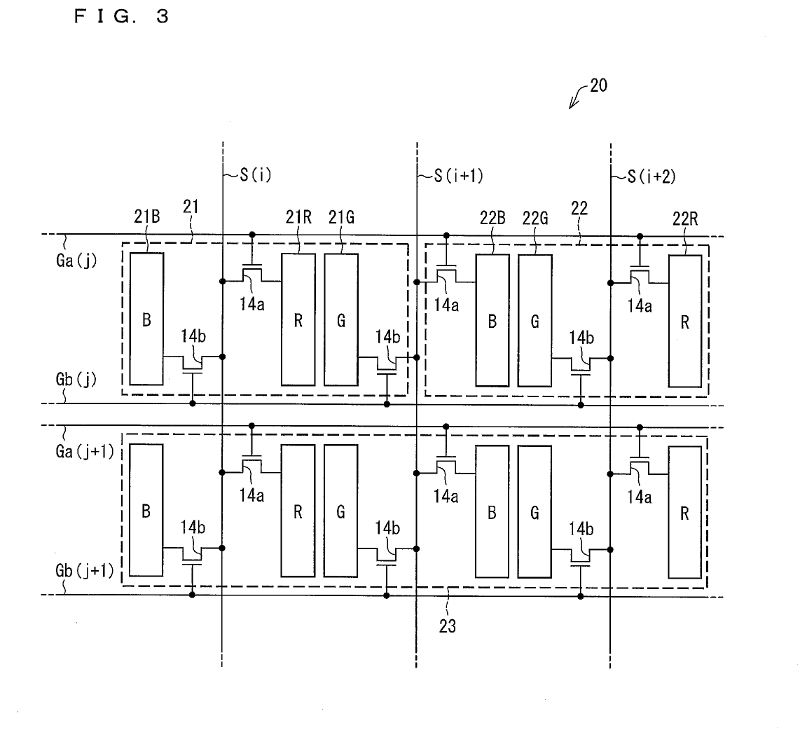

With reference to FIG. 3, the following description will discuss a display element 20 which is a modification of the display element 10. FIG. 3 is a plan view schematically illustrating the display element 20. Members similar to those of the display element 10 are given identical reference signs, and explanations thereof are omitted.

As illustrated in FIG. 3, the display element 20 includes a first picture element 21 and a second picture element 22. The first picture element 21 includes a first sub-picture element 21B, a second sub-picture element 21R, and a third sub-picture element 21G. The second picture element 22 includes a fourth sub-picture element 22B, a fifth sub-picture element 22G, and a sixth sub-picture element 22R. The first sub-picture element 21B, the third sub-picture element 21G, and the fifth sub-picture element 22G are connected with a second gate bus line Gb(j) via respective TFTs 14b. On the other hand, the second sub-picture element 21R, the fourth sub-picture element 22B, and the sixth sub-picture element 22R are connected with a first gate bus line Ga(j) via respective TFTs 14a.

The color alignment of the unit picture element 13 in the display element 10 is “R, G, B, G, R, and B,” whereas the color alignment of a unit picture element 23 in the display element 20 is “B, R, G, B, G, and R.” Therefore, in terms of a color alignment, the display element 20 can be considered as a display element in which sub-picture elements are slid by one sub-picture element in a row direction from their respective positions in the display element 10 while the order of aligning colors in the color alignment of the display element 20 is the same as that in the display element 10. Consequently, two sub-picture elements displaying a green color which has the highest luminance among the primary colors when displaying an achromatic color are connected with the second gate bus line Gb(j), not with the first gate bus line Ga(j). As described above, a charging ratio of a sub-picture element connected with the second gate bus line Gb(j) is higher than that of a sub-picture element connected with the first gate bus line Ga(j). Accordingly, the display element 20 can have higher luminance of green than the display element 10. Therefore, the display element 20 can have a higher luminance of the display element without increasing power consumption of the display element. In other words, the display element 20 can subdue power consumption when realizing the same luminance as that of the display element 10.

### Second Embodiment

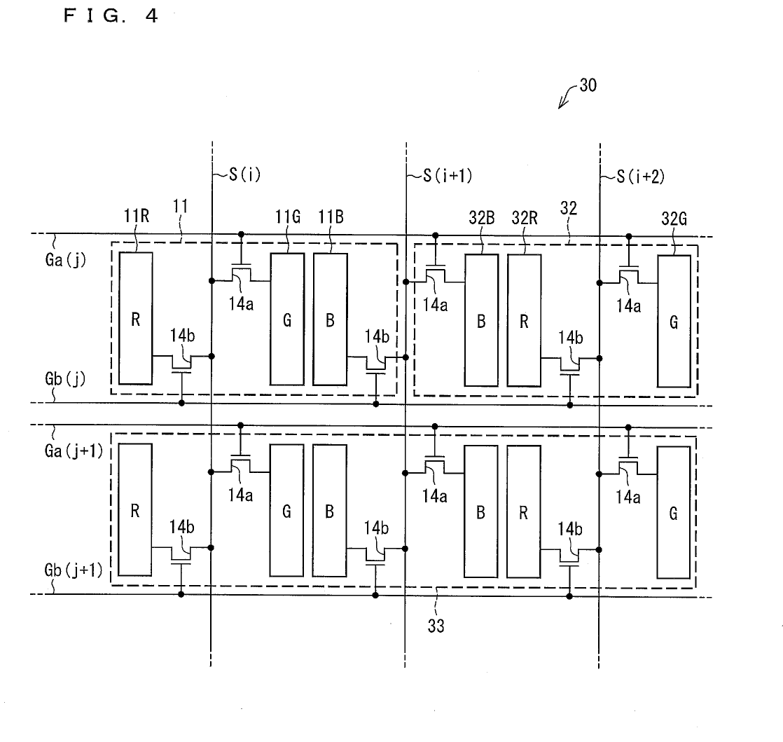

With reference to FIG. 4, the following description will discuss a display element 30 in accordance with Second Embodiment of the present invention. FIG. 4 is a plan view schematically illustrating the display element 30. Members similar to those of the display element 10 are given identical reference signs, and explanations thereof are omitted.

As illustrated in FIG. 4, the display element 30 is different from the display element 10 in terms of a color alignment of sub-picture elements included in a second picture element 32. In the second picture element 32, a fourth sub-picture element 32B displays a blue color, a fifth sub-picture element 32R displays a red color, and a sixth sub-picture element 32G displays a green color. Therefore, a color alignment of a unit picture element 33 is “R, G, B, B, R, and G”.

In the display element 30, a second sub-picture element 11G displaying a green color and the sixth sub-picture element 32G displaying a green color are each connected with a first gate bus line Ga(j). A first sub-picture element 11R displaying a red color and the fifth sub-picture element 32R displaying a red color are each connected with a second gate bus line Gb(j).

On the other hand, a third sub-picture element 11B displaying a blue color is connected with the second gate bus line Gb(j), whereas the fourth sub-picture element 32B displaying a blue color is connected with the first gate bus line Ga(j).

As described above, in the display element 30, among sub-picture elements displaying a red color, a green color, and a blue color, respectively, there is no difference in charging ratio between sub-picture elements displaying a green color which has the strongest influence on visibility, luminance, and chromaticity of a displayed color. There is a difference in charging ratio only between sub-picture elements displaying a blue color which has the lowest luminance and has the smallest influence on a displayed color. Consequently, there are only small differences in luminance and chromaticity between an achromatic color displayed by the first picture element 11 having a color alignment of “R, G, and B” and an achromatic color displayed by the second picture element 32 having a color alignment of “B, R, and G”. This causes a longitudinal streak to be less likely to be visible to a user even when the first picture element 11 and the second picture element 32 display a half tone. That is, the display element 30 can subdue generation of a longitudinal streak visible to a user.

Furthermore, the second sub-picture element 11G displaying a green color and the sixth sub-picture element 32G displaying a green color are provided on right sides of respective source bus lines. The first sub-picture element 11R displaying a red color and the fifth sub-picture element 32R displaying a red color are provided on left sides of respective source bus lines. On the other hand, the third sub-picture element 11B displaying a blue color is provided on a left side of a source bus line, and the fourth sub-picture element 32B displaying a blue color is provided on a right side of that source bus line.

Therefore, in the display element 30, even in a case where misalignment of a manufacturing device occurs in a process of manufacturing a TFT substrate, there is no difference in luminance between sub-picture elements displaying a green color which has the strongest influence on visibility, luminance, and chromaticity of a displayed color. There is a difference in luminance only between sub-picture elements displaying a blue color which has the lowest luminance and has the smallest influence on a displayed color. Consequently, there are only small differences in luminance and chromaticity between an achromatic color displayed by the first picture element 11 having a color alignment of “R, G, and B” and an achromatic color displayed by the second picture element 32 having a color alignment of “B, R, and G”. This causes a longitudinal streak to be less likely to be visible to a user when the first picture element 11 and the second picture element 32 display a half tone. That is, the display element 30 can further subdue generation of a longitudinal streak visible to a user.

The display element 30 may be arranged such that respective TFTs of the first sub-picture element 11R, the third sub-picture element 11B, and the fifth sub-picture element 32R are connected with the first gate bus line Ga(j), and respective TFTs of the second sub-picture element 11G, the fourth sub-picture element 32R, and the sixth sub-picture element 32G are connected with the second gate bus line Gb(j). With this arrangement, both of the second sub-picture element 11G and the sixth sub-picture element 32G are connected with the second gate bus line Gb(j), so that it is possible to increase luminance of the display element 30.

### Third Embodiment

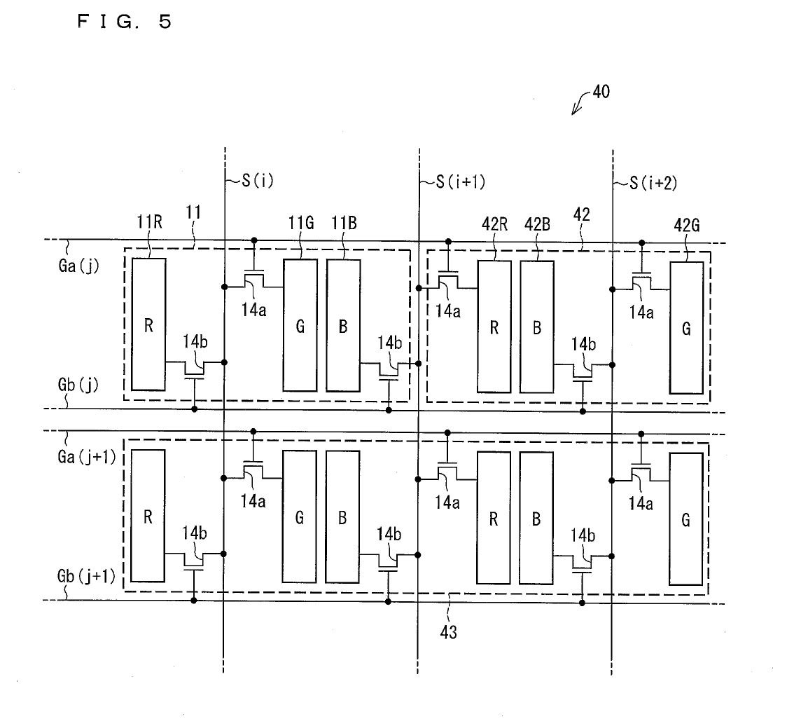

With reference to FIG. 5, the following description will discuss a display element 40 in accordance with Third Embodiment of the present invention. FIG. 5 is a plan view schematically illustrating the display element 40. Members similar to those of the display element 10 are given identical reference signs, and explanations thereof are omitted.

As illustrated in FIG. 5, the display element 40 is different from the display element 10 in terms of a color alignment of sub-picture elements included in a second picture element 42. In the second picture element 42, a fourth sub-picture element 42R displays a red color, a fifth sub-picture element 42B displays a blue color, and a sixth sub-picture element 42G displays a green color. Accordingly, a color alignment of a unit picture element 43 is “R, G, B, R, B, and G”. With the color alignment, R which is a first primary color displayed by the fourth sub-picture element is different from B which is a third primary color displayed by the third sub-picture element. G which is a second primary color displayed by the sixth sub-picture element is different from R which is a primary color displayed by the first sub-picture element. Accordingly, with the color alignment, repeatedly positioning the unit picture elements 43 in a row direction does not have sub-picture elements of the same primary color adjacent to each other.

In the display element 40, a second sub-picture element 11G displaying a green color and the sixth sub-picture element 42G displaying a green color are each connected with a first gate bus line Ga(j). A third sub-picture element 11B displaying a blue color and the fifth sub-picture element 42B displaying a blue color are each connected with a second gate bus line Gb(j).

On the other hand, a first sub-picture element 11R displaying a red color is connected with the second gate bus line Gb(j), whereas the fourth sub-picture element 42R displaying a red color is connected with the first gate bus line Ga(j).

As described above, in the display element 40, among sub-picture elements displaying a red color, a green color, and a blue color, respectively, there is no difference in charging ratio between sub-picture elements displaying a green color which has the strongest influence on visibility, luminance, and chromaticity of a displayed color. Consequently, there are only small differences in luminance and chromaticity between an achromatic color displayed by the first picture element 11 having a color alignment of “R, G, and B” and an achromatic color displayed by the second picture element 42 having a color alignment of “R, B, and G”., This causes a longitudinal streak to be less likely to be visible to a user even when the first picture element 11 and the second picture element 42 display a half tone. That is, the display element 40 can subdue generation of a longitudinal streak visible to a user.

Furthermore, the second sub-picture element 11G displaying a green color and the sixth sub-picture element 32G displaying a green color are provided on right sides of respective source bus lines. The third sub-picture element 11B displaying a blue color and the fifth sub-picture element 42B displaying a blue color are provided on left sides of respective source bus lines. On the other hand, the first sub-picture element 11R displaying a red color is provided on a left side of a source bus line, whereas the fourth sub-picture element 32R displaying a red color is provided on a right side of a source bus line.

Therefore, in the display element 40, even in a case where misalignment of a manufacturing device occurs in a process of manufacturing a TFT substrate, there is no difference in luminance between sub-picture elements displaying a green color which has the strongest influence on visibility, luminance, and chromaticity of a displayed color. Consequently, there are only small differences in luminance and chromaticity between an achromatic color displayed by the first picture element 11 having a color alignment of “R, G, and B” and an achromatic color displayed by the second picture element 42 having a color alignment of “R, B, and G”. This causes a longitudinal streak to be less likely to be visible to a user even when the first picture element 11 and the second picture element 42 display a half tone. That is, the display element 40 can further subdue generation of a longitudinal streak visible to a user.

The display element 40 may be arranged such that respective TFTs of the first sub-picture element 11R, the third sub-picture element 11B, and the fifth sub-picture element 42B are connected with the first gate bus line Ga(j), and respective TFTs of the second sub-picture element 11G, the fourth sub-picture element 42R, and the sixth sub-picture element 42G are connected with the second gate bus line Gb(j). With this arrangement, both of the second sub-picture element 11G and the sixth sub-picture element 42G are connected with the second gate bus line Gb(j), so that it is possible to increase luminance of the display element 40.

### Fourth Embodiment

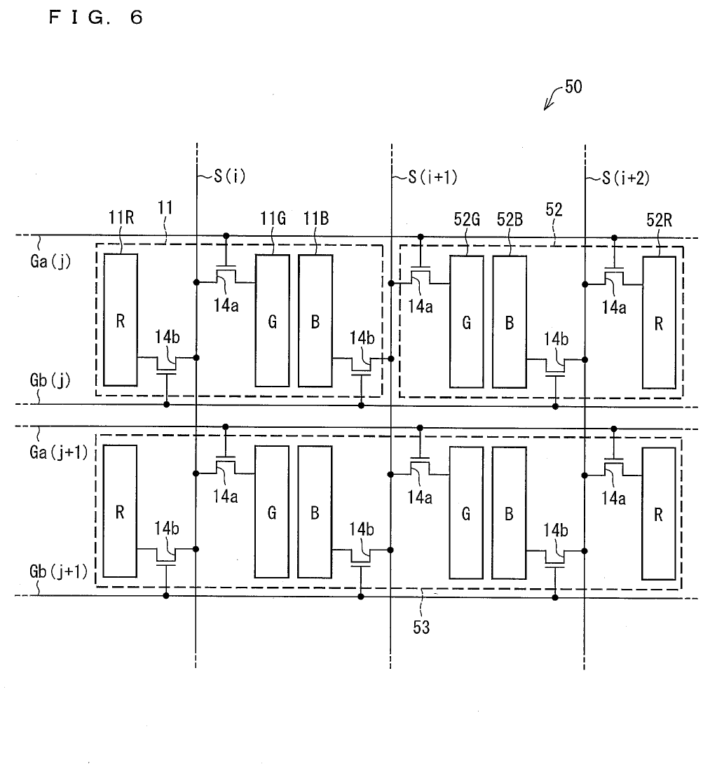

With reference to FIG. 6, the following description will discuss a display element 50 in accordance with Fourth Embodiment of the present invention. FIG. 6 is a plan view schematically illustrating the display element 50. Members similar to those of the display element 10 are given identical reference signs, and explanations thereof are omitted.

As illustrated in FIG. 6, the display element 50 is different from the display element 10 in terms of a color alignment of sub-picture elements included in a second picture element 52. In the second picture element 52, a fourth sub-picture element 52G displays a green color, a fifth sub-picture element 52B displays a blue color, and a sixth sub-picture element 52R displays a red color. Accordingly, a color alignment of a unit picture element 53 is “R, G, B, G, B, and R”.

In the display element 50, a second sub-picture element 11G displaying a green color and the fourth sub-picture element 52G displaying a green color are each connected with a first gate bus line Ga(j). A third sub-picture element 11B displaying a blue color and the fifth sub-picture element 52B displaying a blue color are each connected with a second gate bus line Gb(j).

On the other hand, a first sub-picture element 11R displaying a red color is connected with the second gate bus line Gb(j), whereas the sixth sub-picture element 52R displaying a red color is connected with the first gate bus line Ga(j).

As described above, in the display element 50, among sub-picture elements displaying a red color, a green color, and a blue color, respectively, there is no difference in charging ratio between sub-picture elements displaying a green color which has the strongest influence on visibility, luminance, and chromaticity of a displayed color. Consequently, there are only small differences in luminance and chromaticity between an achromatic color displayed by the first picture element 11 having a color alignment of “R, G, and B” and an achromatic color displayed by the second picture element 52 having a color alignment of “G, B, and R”. This causes a longitudinal streak to be less likely to be visible to a user even when the first picture element 11 and the second picture element 52 display a half tone. That is, the display element 50 can subdue generation of a longitudinal streak visible to a user.

Furthermore, the second sub-picture element 11G displaying a green color and the fourth sub-picture element 52G displaying a green color are provided on right sides of respective source bus lines. The third sub-picture element 11B displaying a blue color and the fifth sub-picture element 42B displaying a blue color are provided on left sides of respective source bus lines. On the other hand, the first sub-picture element 11R displaying a red color is provided on a left side of a source bus line, whereas the sixth sub-picture element 32R displaying a red color is provided on a right side of a source bus line.

Therefore, in the display element 40, even in a case where misalignment of a manufacturing device occurs in a process of manufacturing a TFT substrate, there is no difference in luminance between sub-picture elements displaying a green color which has the strongest influence on visibility, luminance, and chromaticity of a displayed color. Consequently, there are only small differences in luminance and chromaticity between an achromatic color displayed by the first picture element 11 having a color alignment of “R, G, and B” and an achromatic color displayed by the second picture element 52 having a color alignment of “G, B, and R”. This causes a longitudinal streak to be less likely to be visible to a user even when the first picture element 11 and the second picture element 52 display a half tone. That is, the display element 50 can further subdue generation of a longitudinal streak visible to a user.

The display element 50 may be arranged such that the first sub-picture element 11R, the third sub-picture element 11B, and the fifth sub-picture element 52B are connected with the first gate bus line Ga(j), and the second sub-picture element 11G, the fourth sub-picture element 52G, and the sixth sub-picture element 52R are connected with the second gate bus line Gb(j). With this arrangement, both of the second sub-picture element 11G and the fourth sub-picture element 52G are connected with the second gate bus line Gb(j), so that it is possible to increase luminance of the display element 40.

### Fifth Embodiment

(Display Device)

A display device in accordance with Fifth Embodiment of the present invention preferably includes any one of the display elements in accordance with the Embodiments of the present invention. A display device in accordance with one aspect of the present invention, which includes any one of those display elements, can still further subdue generation of a longitudinal streak visible to a user.

### Summary

A display element in accordance with first aspect of the present invention includes: a first signal line, a second signal line, and a third signal line which extend in one direction; a first scanning line and a second scanning line which extend in a direction crossing the first signal line, the second signal line, and the third signal line; and first through sixth sub-picture elements provided between the first scanning line and the second scanning line, the first sub-picture element being provided on one side of the first signal line, displaying a first primary color, and including a first switching element connected with the first signal line and the second scanning line, the second sub-picture element being provided on the other side of the first signal line, displaying a second primary color different from the first primary color, and including a second switching element connected with the second signal line and the first scanning line, the third sub-picture element being provided on one side of the second signal line, displaying a third primary color different from the first primary color and the second primary color, and including a third switching element connected with the second signal line and the second scanning line, the fourth sub-picture element being provided on the other side of the second signal line, displaying one of the first primary color, the second primary color, and the third primary color, and including a fourth switching element connected with the second signal line and the first scanning line, the fifth sub-picture element being provided on one side of the third signal line, displaying another one of the first primary color, the second primary color, and the third primary color which another one is different from said one displayed by the fourth sub-picture element, and including a fifth switching element connected with the third signal line and the second scanning line, and the sixth sub-picture element being provided on the other side of the third signal line, displaying still another one of the first primary color, the second primary color, and the third primary color which still another one is different from said one displayed by the fourth sub-picture element and said another one displayed by the fifth sub-picture element, and including a sixth switching element connected with the third signal line and the first scanning line, and two of the first through sixth sub-picture elements displaying a primary color with a highest luminance out of the first through third primary colors when the first through sixth sub-picture elements display an achromatic color, and respective switching elements of said two sub-picture elements being each connected with one of the first scanning line and the second scanning line.

With the arrangement, in the display element in accordance with one aspect of the present invention, out of the first through sixth sub-picture elements, the first, third, and fifth sub-picture elements whose switching elements are connected with the second scanning line are respectively provided on one sides (left sides) of the signal lines with which the switching elements of the first, third, and fifth sub-picture elements are connected. The second, fourth, and sixth sub-picture elements whose switching elements are connected with the first scanning line are respectively provided on the other sides (right sides) of the signal lines with which the switching elements of the second, fourth, and sixth sub-picture elements are connected.

Furthermore, out of the first through sixth sub-picture elements, two sub-picture elements which transmit a color with the highest luminance out of the first through third colors when the first through sixth sub-picture elements display an achromatic color are connected with one of the first scanning line and the second scanning line.

Luminance of the color with the highest luminance has a significant influence on visibility, luminance, and chromaticity of a displayed color. Since two sub-picture elements displaying the color with the highest luminance are connected with an identical scanning line, there is no difference in charging ratio between the two sub-picture elements. In other words, there is no difference in luminance between the two sub-picture elements. Accordingly, it is possible to subdue, in a display element having a dual gate structure, generation of a longitudinal streak due to an element structure.

Furthermore, the two sub-picture elements are provided on the same sides of the signal lines with which switching elements of the two sub-picture elements are connected, respectively. Consequently, in a process of manufacturing a display element, even when respective switching elements of the first through sixth sub-picture elements are misaligned in a row direction with respect to the first through third signal lines, there is no difference between a distance from the switching element of one of the two sub-picture elements to the corresponding signal line and a distance from the switching element of the other of the two sub-picture elements to the corresponding signal line. Accordingly, there is no difference between (i) a parasitic capacitance Csd between the switching element of one of the two sub-picture elements and the corresponding signal line and (ii) a parasitic capacitance Csd between the switching element of the other of the two sub-picture elements and the corresponding signal line, so that there is no difference in luminance between the two sub-picture elements. Therefore, it is possible to subdue, in a display element having a dual gate structure, generation of a longitudinal streak due to the manufacturing process.

As described above, the display element in accordance with one aspect of the present invention subdues a longitudinal streak due to the element structure and a longitudinal streak due to the manufacturing process. That is, the display element in accordance with one aspect of the present invention further subdues generation of a longitudinal streak which would be visible to a user in a display element having a dual gate structure.

The display element in accordance with second aspect of the present invention may be an arrangement of the first aspect, wherein other two sub-picture elements of the first through sixth sub-picture elements display a primary color with a second highest luminance out of the first through third primary colors, and respective switching elements of said other two sub-picture elements are each connected with the other of the first scanning line and the second scanning line.

With the arrangement, respective switching elements of the two sub-picture elements displaying the primary color with the second highest luminance out of the first through third primary colors are connected with an identical scanning line. Consequently, there is no difference in charging ratio between the two sub-picture elements displaying the primary color with the second highest luminance. Accordingly, there is no difference in luminance between the two sub-picture elements displaying the primary color with the second highest luminance. As described above, since there is no difference in luminance between the two sub-picture elements displaying the primary color with the highest luminance out of the first through third primary colors and there is no difference in luminance between the two sub-picture elements displaying the primary color with the second highest luminance, the display device in accordance with one aspect of the present invention more effectively subdues generation of a longitudinal streak which would be visible to a user in a display element having a dual gate structure.

The display element in accordance with third aspect of the present invention may be an arrangement of the first aspect, wherein other two sub-picture elements of the first through sixth sub-picture elements display a primary color with a third highest luminance out of the first through third primary colors, and respective switching elements of said other two sub-picture elements are each connected with the other of the first scanning line and the second scanning line.

With the arrangement, respective switching elements of the two sub-picture elements displaying the primary color with the third highest luminance out of the first through third primary colors are connected with an identical scanning line. Consequently, there is no difference in charging ratio between the two sub-picture elements displaying the primary color with the third highest luminance. Accordingly, there is no difference in luminance between the two sub-picture elements displaying the primary color with the third highest luminance. As described above, since there is no difference in luminance between the two sub-picture elements displaying the primary color with the highest luminance out of the first through third primary colors and there is no difference in luminance between the two sub-picture elements displaying the primary color with the third highest luminance, the display device in accordance with one aspect of the present invention more effectively subdues generation of a longitudinal streak which would be visible to a user in a display element having a dual gate structure.

The display element in accordance with fourth aspect of the present invention may be an arrangement of any one of the first through third aspects, wherein the fourth sub-picture element displays the first primary color or the second primary color, and the sixth sub-picture element displays the second primary color or the third primary color.

With the arrangement, repeatedly positioning the first through sixth sub-picture elements in a direction in which the first scanning line and the second scanning line extend does not have sub-picture elements of the same primary color adjacent to each other. Consequently, the display device in accordance with one aspect of the present invention subdues generation of a longitudinal streak which would be visible to a user when one of the first through third primary colors is displayed.

The display element in accordance with fifth aspect of the present invention may be an arrangement of any one of the first through fourth aspects, wherein a first scanning signal is supplied to the first scanning line for a predetermined period, a second scanning signal is supplied to the second scanning line for a predetermined period after the first scanning signal is supplied to the first scanning line, and data signals are supplied to the first through third signal lines, respectively, the first scanning signal and the data signals are supplied in synchronization with each other, and respective polarities of the data signals are not changed throughout (i) the predetermined period during which the first scanning signal is supplied and (ii) the predetermined period during which the second scanning signal is supplied, and said respective switching elements of said two sub-picture elements which display the primary color with the highest luminance out of the first through third primary colors are connected with the second scanning line.

With the arrangement, the sub-picture elements whose switching elements are connected with the second scanning line have a higher charging ratio than the sub-picture elements whose switching elements are connected with the first scanning line. That is, when sub-picture elements displaying the same primary color are compared with each other, the sub-picture elements whose switching elements are connected with the second scanning line have a higher luminance than the sub-picture elements whose switching elements are connected with the first scanning line. In the display device in accordance with one aspect of the present invention, respective switching elements of the two sub-picture elements displaying the primary color with the highest luminance out of the first through third primary colors are connected with the second scanning line, so that it is possible to further increase luminance of the display device.

The display element in accordance with sixth aspect of the present invention may be an arrangement of any one of the first through fifth aspects, wherein the first primary color is one of three colors of red, green, and blue, the second primary color is one of the three colors which one is different from the first primary color, and the third primary color is one of the three colors which one is different from the first and second primary colors.

With the arrangement, the display device in accordance with one aspect of the present invention includes sub-picture elements displaying primary colors of red, green, and blue, respectively, and accordingly is a display element capable of displaying color images. That is, the display element in accordance with one aspect of the present invention further subdues generation of a longitudinal streak which would be visible to a user in a display element having a dual gate structure and capable of displaying color images.

A display device in accordance with one aspect of the present invention may include a display element in accordance with one aspect of the present invention.

With the arrangement, the display device in accordance with one aspect of the present invention yields an effect similar to that yielded by the aforementioned display element. That is, the display device can further subdue generation of a longitudinal streak visible to a user.

The present invention is not limited to the description of the embodiments above, but may be altered by a skilled person within the scope of the claims. An embodiment based on a proper combination of technical means disclosed in different embodiments is encompassed in the technical scope of the present invention.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention is widely usable as a display device and a method for driving the display device.

### REFERENCE SIGNS LIST

10 Display element

11 First picture element

12 Second picture element

13 Unit picture element

14a TFT (switching element)

14b TFT (switching element)

Ga First gate bus line (first scanning line)

Gb Second gate bus line (second scanning line)

S Source bus line (signal line)

1. A display element, comprising:
a first signal line, a second signal line, and a third signal line which extend in one direction;
a first scanning line and a second scanning line which extend in a direction crossing the first signal line, the second signal line, and the third signal line; and
first through sixth sub-picture elements provided between the first scanning line and the second scanning line,
the first sub-picture element being provided on one side of the first signal line, displaying a first primary color, and including a first switching element connected with the first signal line and the second scanning line,
the second sub-picture element being provided on the other side of the first signal line, displaying a second primary color different from the first primary color, and including a second switching element connected with the first signal line and the first scanning line,
the third sub-picture element being provided on one side of the second signal line, displaying a third primary color different from the first primary color and the second primary color, and including a third switching element connected with the second signal line and the second scanning line,
the fourth sub-picture element being provided on the other side of the second signal line, displaying one of the first primary color, the second primary color, and the third primary color, and including a fourth switching element connected with the second signal line and the first scanning line,
the fifth sub-picture element being provided on one side of the third signal line, displaying another one of the first primary color, the second primary color, and the third primary color which another one is different from said one displayed by the fourth sub-picture element, and including a fifth switching element connected with the third signal line and the second scanning line, and
the sixth sub-picture element being provided on the other side of the third signal line, displaying still another one of the first primary color, the second primary color, and the third primary color which still another one is different from said one displayed by the fourth sub-picture element and said another one displayed by the fifth sub-picture element, and including a sixth switching element connected with the third signal line and the first scanning line, and
two of the first through sixth sub-picture elements displaying a primary color with a highest luminance out of the first through third primary colors when the first through sixth sub-picture elements display an achromatic color, and respective switching elements of said two sub-picture elements being each connected with one of the first scanning line and the second scanning line.

2. The display element as set forth in claim 1, wherein other two sub-picture elements of the first through sixth sub-picture elements display a primary color with a second highest luminance out of the first through third primary colors, and respective switching elements of said other two sub-picture elements are each connected with the other of the first scanning line and the second scanning line.

3. The display element as set forth in claim 1, wherein other two sub-picture elements of the first through sixth sub-picture elements display a primary color with a third highest luminance out of the first through third primary colors, and respective switching elements of said other two sub-picture elements are each connected with the other of the first scanning line and the second scanning line.

4. The display element as set forth in claim 1, wherein the fourth sub-picture element displays the first primary color or the second primary color, and the sixth sub-picture element displays the second primary color or the third primary color.

5. The display element as set forth in claim 1, wherein
a first scanning signal is supplied to the first scanning line for a predetermined period, a second scanning signal is supplied to the second scanning line for a predetermined period after the first scanning signal is supplied to the first scanning line, and data signals are supplied to the first through third signal lines, respectively,
the first scanning signal and the data signals are supplied in synchronization with each other, and respective polarities of the data signals are not changed throughout (i) the predetermined period during which the first scanning signal is supplied and (ii) the predetermined period during which the second scanning signal is supplied, and
said respective switching elements of said two sub-picture elements which display the primary color with the highest luminance out of the first through third primary colors are connected with the second scanning line.

6. The display element as set forth in claim 1, wherein the first primary color is one of three colors of red, green, and blue, the second primary color is one of the three colors which one is different from the first primary color, and the third primary color is one of the three colors which one is different from the first and second primary colors.

7. A display device, comprising a display element as set forth in claim 1.
